(19) United States
(12) Patent Application Publication
(10) Pub. No.: US 2025/0289051 A1
(43) Pub. Date: Sep. 18, 2025

(54) Quick Attach Pop Riveting Device

(71) Applicant: Filiberto Almaraz, Lenoir, NC (US)

(72) Inventor: Filiberto Almaraz, Lenoir, NC (US)

(21) Appl. No.: 18/958,022

(22) Filed: Nov. 25, 2024

Related U.S. Application Data
(60) Provisional application No. 63/564,517, filed on Mar. 13, 2024.

(51) Int. Cl. B21J 15/10

(52) U.S. Cl. CPC B21J 15/105

(57) ABSTRACT

A quick attach pop riveting device is disclosed, which is an attachment for a screw gun that allows people to use a screw gun as a riveting gun. The quick attach pop riveting device comprises a riveting gun attachment with a non-spinning body component. The non-spinning body component is secured to and around a screw gun or power drill. The riveting gun attachment and the non-spinning body component both include access points for removal and attachment of the components, as needed. The device is easily operated with the attachment and does not spin on the screw gun/power drill and enables users to work without holding the rivets by hand.

### CROSS-REFERENCE TO RELATED APPLICATION

The present application claims priority to, and the benefit of, U.S. Provisional Application No. 63/564,517, which was filed on Mar. 13, 2024, and is incorporated herein by reference in its entirety.

### FIELD OF THE INVENTION

The present invention relates generally to the field of quick attach pop riveting devices. More specifically, the present invention relates to an attachment for screw guns or power drills that allow the tool to function as a riveting gun. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in quick attach pop riveting devices. Generally, people may need access to a standard power drill and a rivet gun to work on different projects. Constantly swapping between two different tools can be frustrating. Further, people may not have free hands to hold up pieces to complete riveting jobs.

Additionally, pop rivets are an incredibly versatile and strong way to secure two pieces of metal together, making them ideal for a variety of applications. Thus, rivets are an important tool for home and industrial projects. A pop rivet drill attachment is necessary to provide the necessary force and torque to properly install the pop rivets. Without the attachment, it would be difficult or even impossible to properly install the rivets. Further, a pop rivet drill attachment makes it easier to drill into hard surfaces such as metal, wood, and plastic. With a pop rivet drill attachment, you can quickly and easily install rivets with precision and accuracy.

Accordingly, there is a demand for an improved quick attach pop riveting device that allows screw guns or power drills to function as a riveting gun. More particularly, there is a demand for a quick attach pop riveting device that saves time and effort when using a power drill and riveting gun on the same jobsite.

Therefore, there exists a long felt need in the art for a quick attach pop riveting device that provides users with an attachment for screw guns or power drills that allow the tool to function as a riveting gun. There is also a long felt need in the art for a quick attach pop riveting device that enables users to quickly attach and detach the device via access points. Further, there is a long felt need in the art for a quick attach pop riveting device that allows users to operate the riveting gun without it spinning on the drill or holding the tool by hand. Moreover, there is a long felt need in the art for a device that saves time and effort when using a power drill and riveting gun on the same jobsite. Further, there is a long felt need in the art for a quick attach pop riveting device that can be utilized with different sized rivets. Finally, there is a long felt need in the art for a quick attach pop riveting device that includes interchangeable attachment heads for different sized rivets.

The subject matter disclosed and claimed herein, in one embodiment thereof, comprises a quick attach pop riveting device. The device is an attachment for a screw gun that allows people to use a screw gun as a riveting gun. The quick attach pop riveting device comprises a riveting gun attachment with a non-spinning body component. The non-spinning body component is secured to and around a screw gun or power drill. The riveting gun attachment and the non-spinning body component both include access points for removal and attachment of the components, as needed. The device is easily operated with the attachment and does not spin on the screw gun/power drill and enables users to work without holding the rivets by hand.

In this manner, the quick attach pop riveting device of the present invention accomplishes all of the forgoing objectives and provides users with a device that attaches to power drills to allow the tool to function as a riveting gun. The device is an attachment with a non-spinning body component which converts a power drill to a riveting gun. The device has access points for removal and attachment.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a quick attach pop riveting device. The device is an attachment for a screw gun that allows people to use a screw gun as a riveting gun. The quick attach pop riveting device comprises a riveting gun attachment with a non-spinning body component. The non-spinning body component is secured to and around a screw gun or power drill. The riveting gun attachment and the non-spinning body component both include access points for removal and attachment of the components, as needed. The device is easily operated with the attachment and does not spin on the screw gun/power drill and enables users to work without holding the rivets by hand.

In one embodiment, people may need access to a standard power drill and a rivet gun to work on different projects, and constantly swapping between two different tools can be frustrating. Accordingly, the quick attach pop riveting device is an attachment for a screw gun or a power drill that allows users to use a screw gun or power drill as a riveting gun.

In one embodiment, the quick attach pop riveting device is secured to and around a screw gun or power drill. The power drill is typically a ⅜″ reversible drill but can be any suitable drill as is known in the art. This attachment device is also compatible with electric drills, air drills, and cordless drills, etc., or any other suitable drill as is known in the art. Further, the drill can be a ½″ or any other suitable size drill as is known in the art.

In one embodiment, the quick attach pop riveting device comprises a riveting gun attachment with a non-spinning body component. The non-spinning body component is configured in a cylindrical shape with open opposing ends and an open interior cavity. A first opposing end is shaped to secure to a power drill or screw gun body. Typically, the non-spinning body component comprises at least one access point to secure it to the power drill or screw gun body. The access point is a spring-clip or interference clip, etc., or any other suitable releasable securing means as is known in the art to allow a user to easily secure and remove the non-spinning body component as needed. Further, the second opposing end is secured to the riveting gun attachment via at least one access point. The second opposing end also comprises a bushing or bearing to allow the power drill or screw gun to spin, while the non-spinning body component remains still.

In one embodiment, the riveting gun attachment comprises a body component with opposing ends, wherein the first opposing end is a rivet head for securing to a pop rivet, during use and the second opposing end secures to the non-spinning body component via at least one access point. Further, the body component includes the at least one access point to allow the riveting gun attachment to be secured to the second opposing end of the non-spinning body component. Further, the riveting gun attachment includes a worm gear or other suitable means for turning the rotation of the power drill to linear actuation or linear pulling for the riveting gun attachment. Thus, once secured, the device is easily operated with the riveting gun attachment and does not spin on the screw gun/power drill and enables users to work without holding the rivets by hand.

In one embodiment, the riveting gun attachment can be configured in different embodiments to be used on different shapes and types of rivets.

In one embodiment, the riveting gun attachment can comprise different rivet heads, which are interchangeable heads for different sized rivets. Typically, the device works with ⅛″- 3/16″ sized rivets. Specifically, the different sized rivet heads, can be 3/32″, ⅛″, 5/32″, and 3/16″, etc. Accordingly, this device is incredibly versatile and can be used for a variety of projects.

In one embodiment, the quick attach pop riveting device is manufactured of a heave-duty and durable plastic. Specifically, the device can be manufactured from heat-scalable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc. Generally, the quick attach pop riveting device is also manufactured from a material that is water resistant or waterproof or comprises a coating that is water resistant or waterproof.

In yet another embodiment, the quick attach pop riveting device comprises a plurality of indicia.

In yet another embodiment, a method of converting a power drill into a riveting gun is disclosed. The method includes the steps of providing a quick attach pop riveting device comprising a riveting gun attachment and a non-spinning body component. The method also comprises securing the non-spinning body component to a power drill via at least one access point. Further, the method comprises attaching the riveting gun attachment to the non-spinning body component via at least one access point. The method also comprises providing a means for converting rotation of the power drill into linear actuation to secure the pop rivet. Finally, the method comprises utilizing the power drill and attachments as a riveting gun.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the quick attach pop riveting device of the present invention showing the device secured to power drills in accordance with the disclosed architecture;

FIG. 2 illustrates a perspective view of one embodiment of the quick attach pop riveting device of the present invention showing a riveting gun attachment secured to a power drill in accordance with the disclosed architecture;

FIG. 3 illustrates a perspective view of one embodiment of the quick attach pop riveting device of the present invention showing a second riveting gun attachment secured to a power drill in accordance with the disclosed architecture;

FIG. 4 illustrates a perspective view of one embodiment of the quick attach pop riveting device of the present invention showing the riveting gun attachment in accordance with the disclosed architecture;

FIG. 5 illustrates a perspective view of one embodiment of the quick attach pop riveting device of the present invention showing the second riveting gun attachment in accordance with the disclosed architecture; and

FIG. 6 illustrates a flowchart showing the method of converting a power drill into a riveting gun in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a quick attach pop riveting device that provides users with an attachment for screw guns or power drills that allow the tool to function as a riveting gun. There is also a long felt need in the art for a quick attach pop riveting device that enables users to quickly attach and detach the device via access points. Further, there is a long felt need in the art for a quick attach pop riveting device that allows users to operate the riveting gun without it spinning on the drill or holding the tool by hand. Moreover, there is a long felt need in the art for a device that saves time and effort when using a power drill and riveting gun on the same jobsite. Further, there is a long felt need in the art for a quick attach pop riveting device that can be utilized with different sized rivets. Finally, there is a long felt need in the art for a quick attach pop riveting device that includes interchangeable attachment heads for different sized rivets.

The present invention, in one exemplary embodiment, is a novel quick attach pop riveting device. The device is an attachment for a screw gun that allows people to use a screw gun as a riveting gun. The quick attach pop riveting device comprises a riveting gun attachment with a non-spinning body component. The non-spinning body component is secured to and around a screw gun or power drill. The riveting gun attachment and the non-spinning body component both include access points for removal and attachment of the components, as needed. The device is easily operated with the attachment and does not spin on the screw gun/power drill and enables users to work without holding the rivets by hand. The present invention also includes a novel method of converting a power drill into a riveting gun. The method includes the steps of providing a quick attach pop riveting device comprising a riveting gun attachment and a non-spinning body component. The method also comprises securing the non-spinning body component to a power drill via at least one access point. Further, the method comprises attaching the riveting gun attachment to the non-spinning body component via at least one access point. The method also comprises providing a means for converting rotation of the power drill into linear actuation to secure the pop rivet. Finally, the method comprises utilizing the power drill and attachments as a riveting gun.

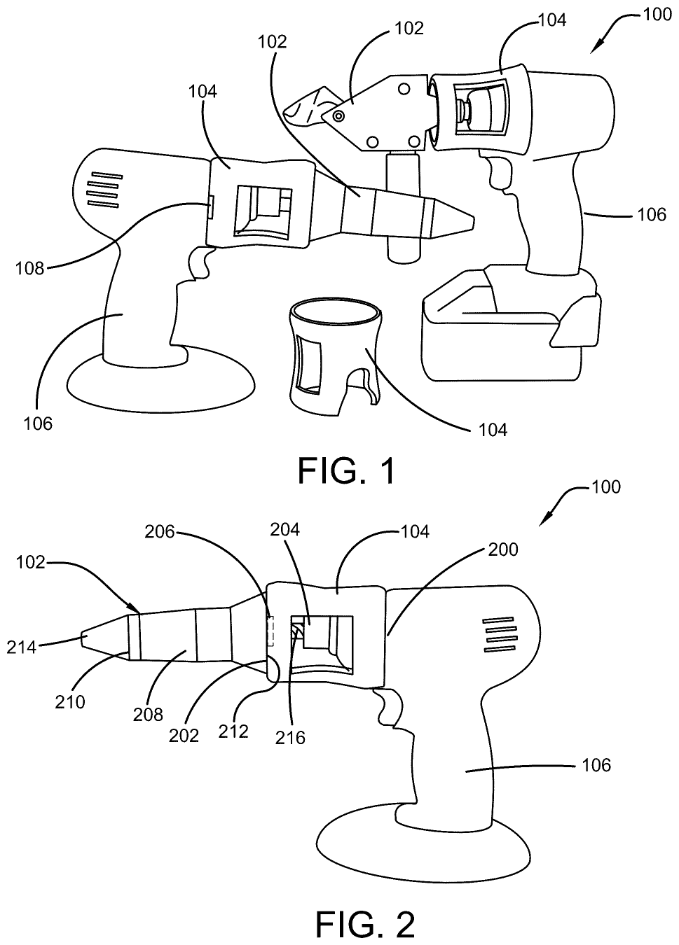

Referring initially to the drawings, FIG. 1 illustrates a perspective view of one embodiment of the quick attach pop riveting device 100 of the present invention. In the present embodiment, the quick attach pop riveting device 100 is an improved quick attach pop riveting device 100 that provides a user with an attachment for screw guns or power drills. Specifically, the quick attach pop riveting device 100 comprises a riveting gun attachment 102 and a non-spinning body component 104. The non-spinning body component 104 is secured to and around a screw gun or power drill 106. The riveting gun attachment 102 and the non-spinning body component 104 both include access points 108 for removal and attachment of the components 102, 104, as needed. The device 100 is easily operated with the attachment and does not spin on the screw gun/power drill 106 and enables users to work without holding the rivets by hand.

Generally, pop rivets (not shown) are an incredibly versatile and strong way to secure two pieces of metal together, making them ideal for a variety of applications. Pop rivets, also known as blind rivets, are a type of rivet. They are used in applications where there is limited, or no, access to the rear side (blind side) of the parts to be joined. Typically, pop rivets consist of two parts. The first part is called the rivet body (also known as the shell or hat) and the second part is called the mandrel (also known as the stem). In situations where access to both sides of a component is limited, a hole is first drilled through the parts to be joined. A pop rivet is then inserted through the drilled hole and the rivet body is brought into contact with the parts. A pop rivet gun is placed on the rivet, pulling the mandrel into the rivet body, causing it to expand and grip the parts to be joined. Once gripped, the mandrel snaps, permanently holding the rivet in place. Thus, once the joint is complete, the mandrel is snapped off at a pre-set nick for a clean finish. These rivets are called “pop rivets” because of the sound you hear when the mandrel breaks off. This results in a localized joint. Accordingly, they are used to make high strength joints in a range of materials, including metals, plastics, wood and leather. Typically, the process is used for joining plastic or sheet metal. Installation is usually completed with a single, gentle pulling motion, but the force required for installation depends on the size of the rivet and its application. For heavy applications such as manufacturing or construction, you should use a pneumatic or electric pop riveting tool that provides more pulling force.

Furthermore, people may need access to a standard power drill 106 and a rivet gun to work on different projects, and constantly swapping between two different tools can be frustrating. Accordingly, the quick attach pop riveting device 100 is an attachment for a screw gun or a power drill 106 that allows users to use a screw gun or power drill 106 as a riveting gun.

Additionally, the quick attach pop riveting device 100 is secured to and around a screw gun or power drill 106. The power drill 106 is typically a ⅜″ reversible drill but can be any suitable drill as is known in the art. This attachment device 100 is also compatible with electric drills, air drills, and cordless drills, etc., or any other suitable drill as is known in the art. Further, the drill 106 can be a ½″ or any other suitable size drill as is known in the art.

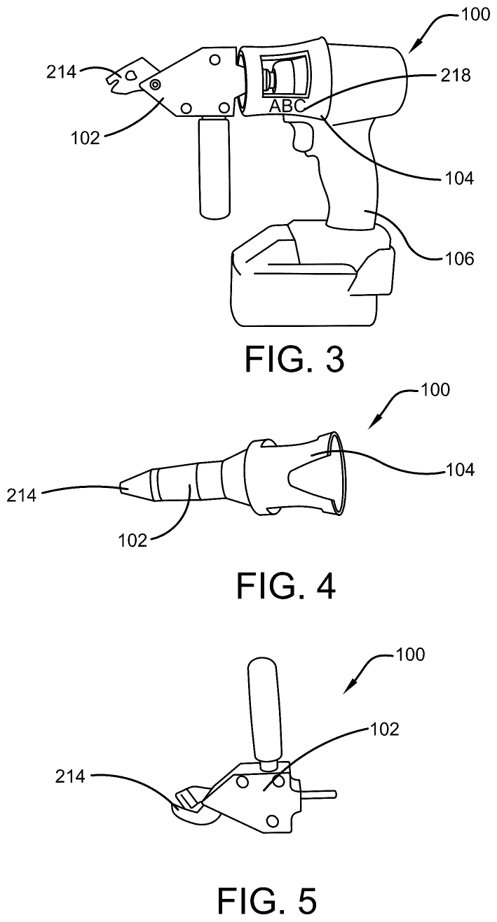

As shown in FIGS. 2-3, the quick attach pop riveting device 100 comprises a riveting gun attachment 102 with a non-spinning body component 104. The non-spinning body component 104 is configured in a cylindrical shape with open opposing ends 200, 202 and an open interior cavity 204. A first opposing end 200 is shaped to secure to a power drill 106 or screw gun body. Typically, the non-spinning body component 104 comprises at least one access point 108 to secure it to the power drill 106 or screw gun body. The access point 108 is a spring-clip or interference clip, etc., or any other suitable releasable securing means as is known in the art to allow a user to casily secure and remove the non-spinning body component 104 as needed. Further, the second opposing end 202 is secured to the riveting gun attachment 102 via at least one access point 108. The second opposing end 202 also comprises a bushing 206 or bearing to allow the power drill 106 or screw gun to spin, while the non-spinning body component 104 remains still.

Further, the riveting gun attachment 102 comprises a body component 208 with opposing ends 210, 212, wherein the first opposing end 210 is a rivet head 214 for securing to a pop rivet, during use and the second opposing end 212 secures to the non-spinning body component 104 via at least one access point 108. Further, the body component 208 includes the at least one access point 108 to allow the riveting gun attachment 102 to be secured to the second opposing end 212 of the non-spinning body component 104. Further, the riveting gun attachment 102 includes a worm gear 216 or other suitable means for turning the rotation of the power drill 106 to linear actuation or linear pulling for the riveting gun attachment 102. Thus, once secured, the device 100 is easily operated with the riveting gun attachment 102 and does not spin on the screw gun/power drill 106 and enables users to work without holding the rivets by hand.

As shown in FIGS. 4-5, the riveting gun attachment 102 can be configured in different embodiments to be used on different shapes and types of rivets.

Further, the riveting gun attachment 102 can comprise different rivet heads 214, which are interchangeable heads for different sized rivets. Typically, the device 100 works with ⅛″- 3/16″ sized rivets. Specifically, the different sized rivet heads 214, can be 3/32″, ⅛″, 5/32″, and 3/16″, etc. Accordingly, this device is incredibly versatile and can be used for a variety of projects.

In one embodiment, the quick attach pop riveting device 100 is manufactured of a heave-duty and durable plastic. Specifically, the device 100 can be manufactured from heat-scalable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc. Generally, the quick attach pop riveting device 100 is also manufactured from a material that is water resistant or waterproof or comprises a coating that is water resistant or waterproof.

In yet another embodiment, the quick attach pop riveting device 100 comprises a plurality of indicia 218. The non-spinning body component 104 of the device 100 may include advertising, a trademark, or other letters, designs, or characters, printed, painted, stamped, or integrated into the non-spinning body component 104, or any other indicia 218 as is known in the art. Specifically, any suitable indicia 218 as is known in the art can be included, such as but not limited to, patterns, logos, emblems, images, symbols, designs, letters, words, characters, animals, advertisements, brands, etc., that may or may not be power drill, pop rivet, or brand related.

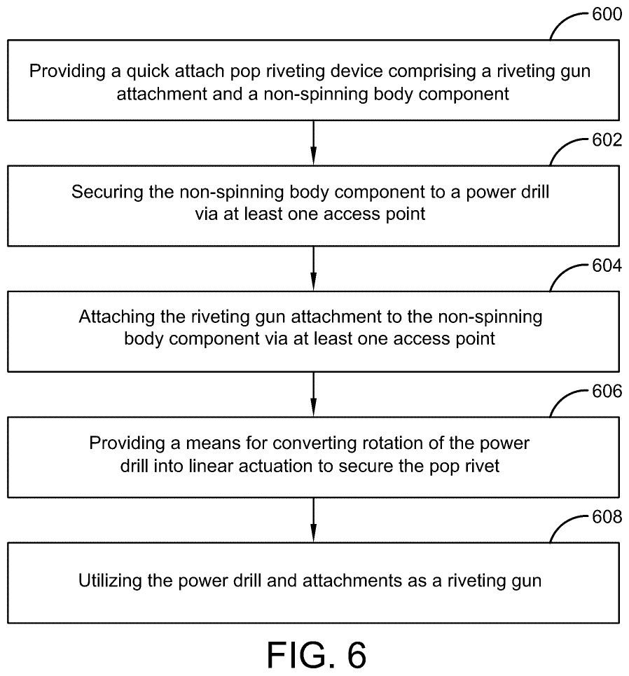

FIG. 6 illustrates a flowchart of the method of converting a power drill into a riveting gun. The method includes the steps of at 600, providing a quick attach pop riveting device comprising a riveting gun attachment and a non-spinning body component. The method also comprises at 602, securing the non-spinning body component to a power drill via at least one access point. Further, the method comprises at 604, attaching the riveting gun attachment to the non-spinning body component via at least one access point. The method also comprises at 606, providing a means for converting rotation of the power drill into linear actuation to secure the pop rivet. Finally, the method comprises at 608, utilizing the power drill and attachments as a riveting gun.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “quick attach pop riveting device”, “pop riveting device”, and “device” are interchangeable and refer to the quick attach pop riveting device 100 of the present invention.

Notwithstanding the forgoing, the quick attach pop riveting device 100 of the present invention can be of any suitable size and configuration as is known in the art without affecting the overall concept of the invention, provided that it accomplishes the above stated objectives. One of ordinary skill in the art will appreciate that the quick attach pop riveting device 100 as shown in FIGS. 1-6 is for illustrative purposes only, and that many other sizes and shapes of the quick attach pop riveting device 100 are well within the scope of the present disclosure. Although the dimensions of the quick attach pop riveting device 100 are important design parameters for user convenience, the quick attach pop riveting device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A quick attach pop riveting device that provides a user with an attachment for screw guns and power drills, the quick attach pop riveting device comprising:
a riveting gun attachment; and
a non-spinning body component;
wherein the non-spinning body component is secured to and around a screw gun or power drill;
wherein the riveting gun attachment is secured to the non-spinning body component; and
further wherein the quick attach pop riveting device does not spin on the screw gun or power drill and enables users to easily and quickly install pop rivets.

2. The quick attach pop riveting device of claim 1, wherein the power drill is a ⅜″ reversible drill.

3. The quick attach pop riveting device of claim 2, wherein the quick attach pop riveting device is also compatible with electric drills, air drills, and cordless drills.

4. The quick attach pop riveting device of claim 3, wherein the non-spinning body component is configured in a cylindrical shape with open first and second opposing ends and an open interior cavity.

5. The quick attach pop riveting device of claim 4, wherein the first opposing end is shaped to secure to a power drill or screw gun body.

6. The quick attach pop riveting device of claim 5, wherein the non-spinning body component comprises at least one access point to secure it to the power drill or screw gun body.

7. The quick attach pop riveting device of claim 6, wherein the at least one access point is a spring-clip or interference clip.

8. The quick attach pop riveting device of claim 7, wherein the second opposing end is secured to the riveting gun attachment via the at least one access point.

9. The quick attach pop riveting device of claim 8, wherein the second opposing end also comprises a bushing or bearing to allow the power drill or screw gun to spin, while the non-spinning body component remains still.

10. The quick attach pop riveting device of claim 9, wherein the riveting gun attachment comprises a body component with first and second opposing ends.

11. The quick attach pop riveting device of claim 10, wherein the first opposing end has a rivet head for securing to a pop rivet, during use.

12. The quick attach pop riveting device of claim 11, wherein the second opposing end secures to the non-spinning body component via the at least one access point.

13. The quick attach pop riveting device of claim 12, wherein the riveting gun attachment includes a worm gear for turning rotation of the power drill or screw gun to linear actuation for the riveting gun attachment.

14. A quick attach pop riveting device that provides a user with an attachment for screw guns and power drills, the quick attach pop riveting device comprising:
a riveting gun attachment comprising a body component with first and second opposing ends; and
a non-spinning body component configured in a cylindrical shape with open first and second opposing ends and an open interior cavity;
wherein the first opposing end of the non-spinning body component is shaped to secure to a power drill or screw gun body;
wherein the non-spinning body component comprises at least one access point to secure it to the power drill or screw gun body;
wherein the at least one access point is a spring-clip or interference clip;
wherein the second opposing end of the non-spinning body component is secured to the riveting gun attachment via the at least one access point and comprises a bushing to allow the power drill or screw gun to spin, while the non-spinning body component remains still;
wherein the first opposing end of the riveting gun attachment has a rivet head for securing to a pop rivet, during use;
wherein the second opposing end of the riveting gun attachment secures to the non-spinning body component via the at least one access point;
wherein the riveting gun attachment includes a worm gear for turning rotation of the power drill or screw gun to linear actuation for the riveting gun attachment; and
further wherein the quick attach pop riveting device does not spin on the screw gun or power drill and enables users to easily and quickly install pop rivets.

15. The quick attach pop riveting device of claim 14, wherein the riveting gun attachment is configured in different embodiments to be used on different shapes and types of rivets.

16. The quick attach pop riveting device of claim 14, wherein the riveting gun attachment comprises different rivet heads, which are interchangeable heads for different sized rivets.

17. The quick attach pop riveting device of claim 16, wherein the interchangeable heads work with ⅛″- 3/16″ sized rivets.

18. The quick attach pop riveting device of claim 14, wherein the quick attach pop riveting device is manufactured of a heave-duty and durable plastic.

19. The quick attach pop riveting device of claim 14 further comprising a plurality of indicia.

20. A method of converting a power drill into a riveting gun, the method comprising the following steps:
providing a quick attach pop riveting device comprising a riveting gun attachment and a non-spinning body component;
securing the non-spinning body component to a power drill via at least one access point; attaching the riveting gun attachment to the non-spinning body component via at least one access point;
providing a means for converting rotation of the power drill into linear actuation to secure the pop rivet; and
utilizing the power drill and attachments as a riveting gun.
